(19) United States
(12) Patent Application Publication
(10) Pub. No.: US 2017/0128897 A1
(43) Pub. Date: May 11, 2017

(54) NAIL POLISH SHAKER

(71) Applicant: Tung-Lin LU, New Taipei City (TW)

(72) Inventor: Tung-Lin LU, New Taipei City (TW)

(21) Appl. No.: 15/072,830

(22) Filed: Mar. 17, 2016

(30) Foreign Application Priority Data
Nov. 5, 2015 (TW) 104217744

(51) Int. Cl. B01F 11/00; A45D 34/04; A45D 29/00

(52) U.S. Cl. CPC B01F 11/0022; A45D 29/00; A45D 34/045; B01F 11/0008; B01F 2215/0031

(57) ABSTRACT

A nail polish shaker is disclosed. In the nail polish shaker, a support member supporting a nail polish bottle is driven by a motor to move upward and downward for shaking the nail polish bottle, so as to uniformly mix the nail polish contained in the nail polish bottle. In addition, the support member can be rotated leftward or rightward by a desired angle, to facilitate take or place the nail polish bottle.

### BACKGROUND OF THE INVENTION

1. Field of the Invention

The present invention relates to nail polish, more particularly to a machine capable of uniformly mixing the nail polish contained in a bottle.

2. Description of the Related Art

Generally, a primary component of the nail polish is solvent or diluent which is added for making color of the nail polish uniform and speeding drying of the nail polish. The secondary component of the nail polish is film-forming agent which is the primary component for forming a film coated with the nail polish, improving softness and toughness of the film, and reducing fragility of the film. The nail polish can further include plastic agent to facilitate the coating of the nail polish and increase the plasticity of the nail polish. The primary objective of coating the nail polish is to decorate nail, so it is necessary to add colorant and pigment in aforesaid components to make the nail polish colorful. In addition, the nail polish can further include other auxiliary component, such as dispersant, stabilizer or enhancer, to facilitate uniform distribution of the pigment and increase soundness and stability of the nail polish product.

Aforesaid components of the nail polish are mixed uniformly during a manufacturing process. However, after the manufacturing process, the components of the nail polish contained in the nail polish bottle may be separated or non-uniform because of long still placement of the nail polish bottle or effect of ambient environmental (such as temperature or humidity). The non-uniform problem of the nail polish can be solved by shaking.

### SUMMARY OF THE INVENTION

An objective of the present invention is to provide a solution in how to shake the nail polish contained in bottle.

The present invention provides a nail polish shaker comprising a base, a mounting frame, a motor, a carry plate, a support member and a restricting member. The base is combined with a shell member having a front part combined with a panel. The mounting frame is fixed on the base and located inside the shell member. The motor is fixed on the back of the mounting frame, and has a rotation axis passed through the mounting frame to connect with a cam. The carry plate is located on a front side of the panel, and has a slidable member located on the back thereof. The slidable member is passed through longitudinal holes of the panel and the mounting frame to connect with the mounting frame and has a contact member located at a bottom thereof to be contacted with an edge of the cam. The support member has a bracket disposed therein and a rear end connected with the carry plate. The restricting member includes a front panel and a fixture connected with the front panel. The front panel is connected to a front end of the support member, and the fixture is located over the bracket.

Preferably, the motor is coupled to a microprocessor assembly which is configured to control different revolving speed of the motor. The microprocessor assembly is further coupled to a control switch which is disposed on the base, and the user can press the control switch to control turning on/off, and the revolving speed of the motor.

By means of aforesaid structural design, a nail polish bottle, in which nail polish is contained, is placed upside-down on the support member with a posture of a lid of the nail polish bottle being lower than a bottle. The lid of the nail polish bottle is supported by the bracket, and the bottle of the nail polish bottle is clamped by the fixture. When the motor is activated, the cam is rotated to drive the carry plate, the support member and the restricting member to move upward and downward for shaking the nail polish bottle upward and downward, so as to mix the nail polish.

The nail polish shaker of the present invention can be used to uniformly mix the components of the nail polish.

The nail polish bottle can be placed on the support member upside-down and the fixture of the present invention can be used to clamp different sizes and types of bottles, other nail polish bottle can be prevented from escaping from the support member during longitudinal shake.

While the support member is applied a forward pull force, the user can rotate the support member and restricting member, so as to conveniently take of place the nail polish bottle without rubbing against the panel of the shaker.

The nail polish shaker of the present invention can be operated in different motor speed, so that the mixing effect can be maximized.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is an elevational view of a shaker of the present invention.

FIG. 2 is a perspective back view of the shaker of the present invention, without a shell member.

FIG. 3 is a side view of the shaker of the present invention, illustrating that the shell member of the shaker is unloaded and the shaker is performing longitudinal shaking.

FIG. 4 is a front view of FIG. 3.

FIG. 5 is a side view of the shaker of the present invention, illustrating that the shell member of the shaker is unloaded and the shaker is performing longitudinal shaking.

FIG. 6 is a front view of FIG. 5.

FIG. 7 is a side view of the shaker of the present invention, illustrating that the shell member of the shaker is unloaded and the support member and the restricting member is pulled forwardly.

FIG. 8 is a schematic view of putting a nail polish bottle in or taking the nail polish bottle from the shaker of the present invention.

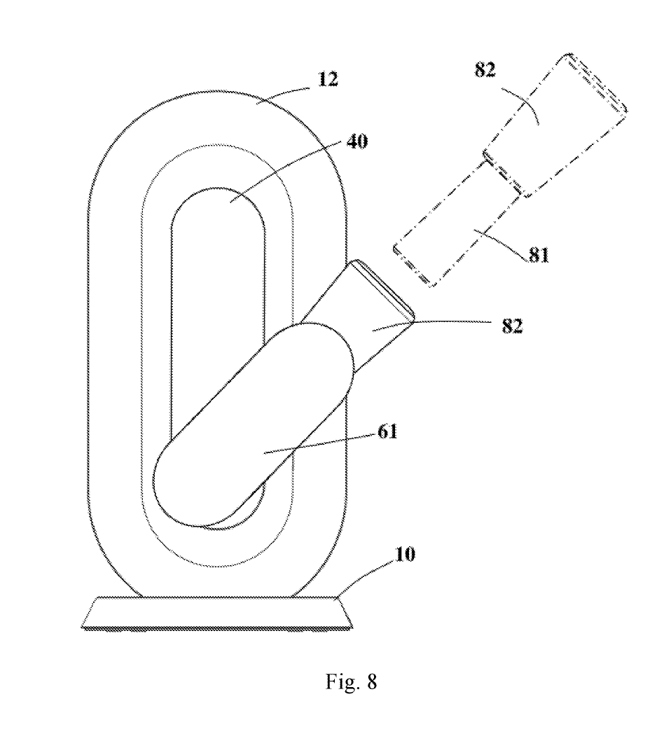

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

The nail polish shaker of the present invention includes a base 10, a mounting frame 20, a motor 30, a carry plate 40, a support member 50 and a restricting member 60.

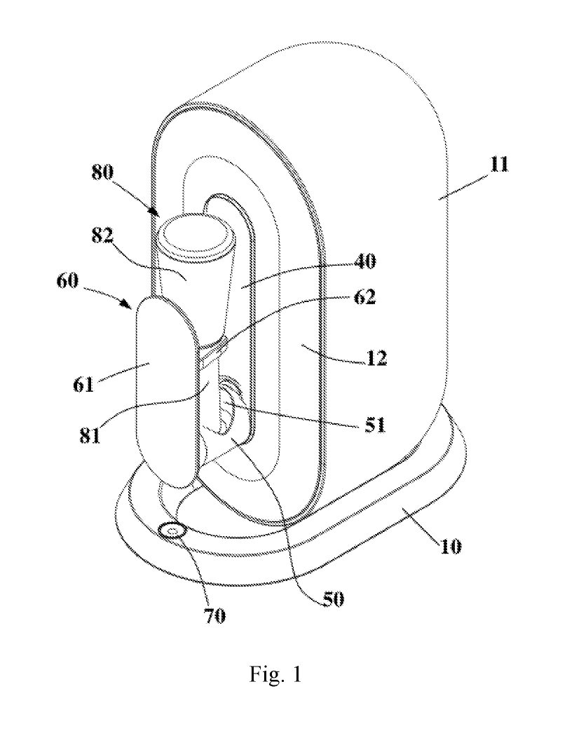

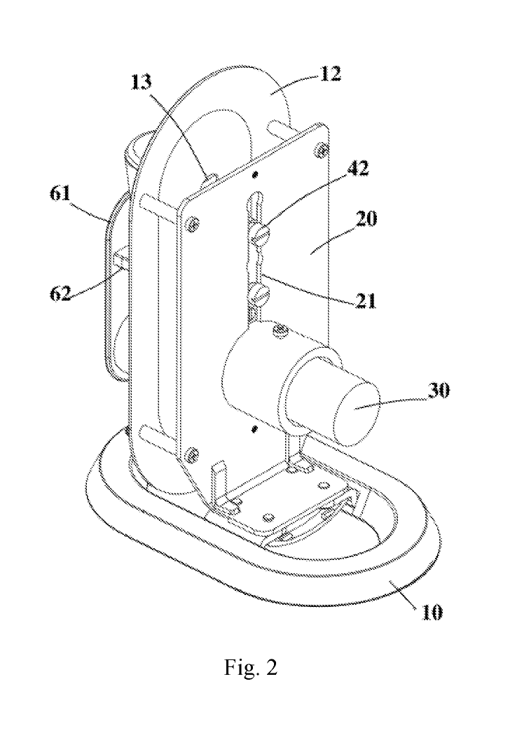

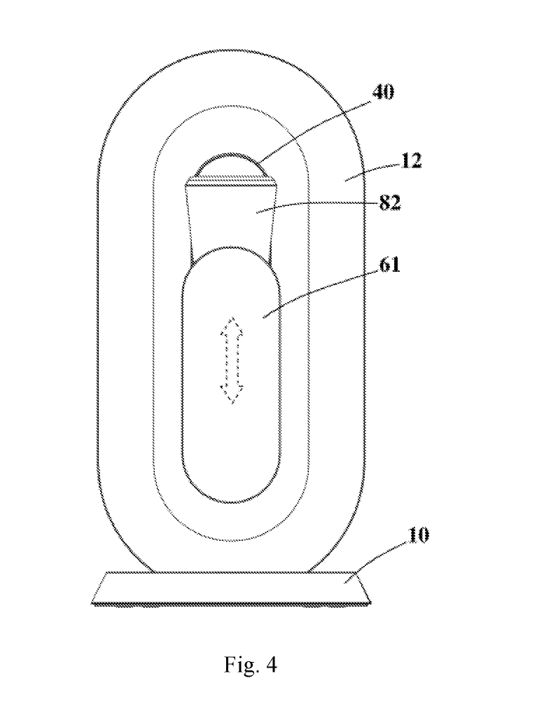

As shown in FIGS. 1 through 4, a shell member 11 is combined on the base 10, and a panel 12 is combined with a front part of the shell member 11. The mounting frame 20 is fixed with the base 10 and the panel 12, and located inside the shell member 11. The motor 30 is fixed on at a rear part of the mounting frame 20, and has a rotation axis passed through the mounting frame 20 to connect with a cam 31. The carry plate 40 is located on a front surface of the panel 12. A slidable member 41 is disposed on a back side of the carry plate 40 and passed through a longitudinal hole 13 of the panel 12. Thread parts of two screws 42 are inserted through a longitudinal hole 21 of the mounting frame 20 to be locked on the back of the slidable member 41. Therefore, the two screws 42 are functioned as the restricting member guiding the carry plate 40 and the slidable member 41 to slide up and down along the longitudinal holes 13 and 21. The slidable member 41 has a contact member 43 configured to contact an edge of the cam 31. The support member 50 has a bracket 51 disposed thereon and a rotatable member 52 disposed the back thereof. The rotatable member 52 is inserted through preset round holes of the carry plate 40 and the panel 12, and diameters of the round holes are fitted with each other. A stop member 53 is disposed at a rear end of the rotatable member 52, and a spring 54 is disposed between the stop member 53 and the panel 12. The restricting member 60 includes a front panel 61 and a fixture 62 connected with the front panel 61. The front panel 61 is connected with a front end of the support member 50 and the fixture 62 is located over the bracket 51.

Moreover, the motor 30 and a microprocessor assembly (not shown in drawings) are coupled with each other, and the microprocessor assembly is configured to control the power and the motor speed of the nail polish shaker. The microprocessor assembly is electrically coupled to a control switch 70 which is disposed on the base 10 to provide a user to press for controlling on/off of the power and the revolving speed of the motor 30.

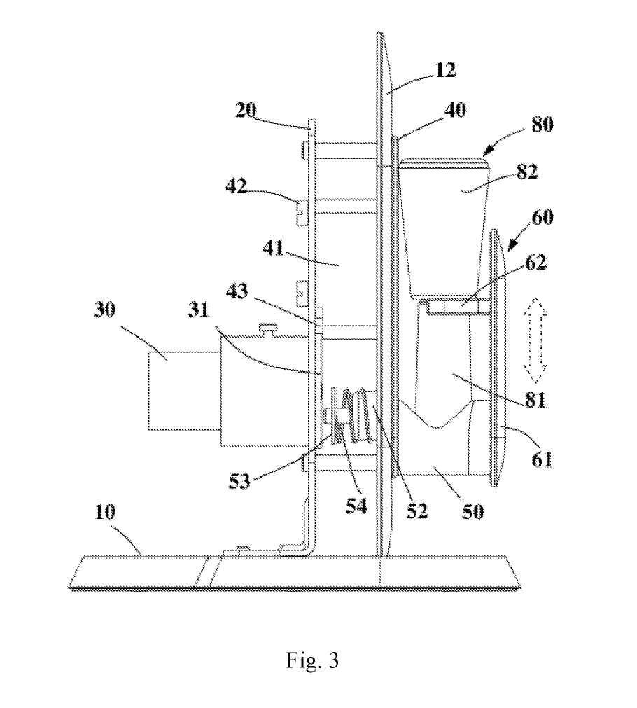

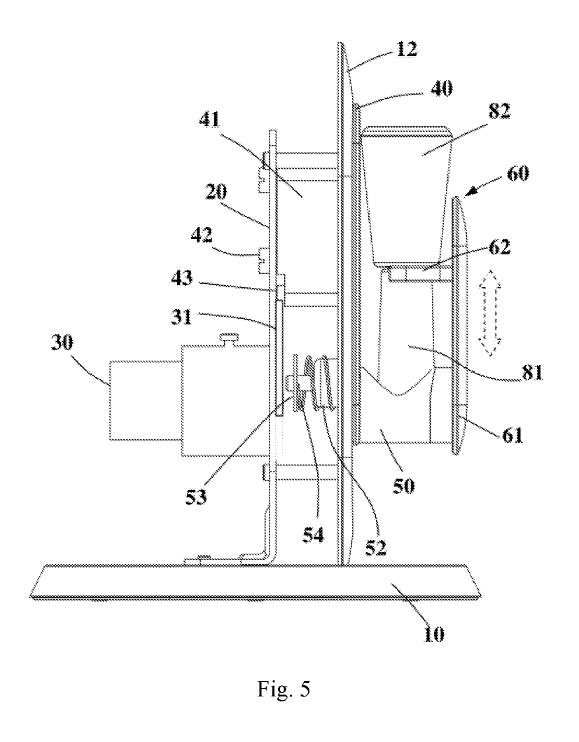

Please refer to FIGS. 3 through 6. A nail polish bottle 80, in which nail polish is contained, is placed upside-down in the bracket 51 of the support member 50 with a posture of a lid 81 of the nail polish bottle being lower than a bottle 82 of the nail polish bottle. The lid 81 of the nail polish bottle is supported by the bracket 51 and the bottle 82 of the nail polish bottle is clamped by the fixture 62. After the motor 30 is activated to rotate the cam 31, the edge of the cam 31 passes and contacts the contact member 43 to make the carry plate 40, the support member 50 and the restricting member 60 move upward and downward, so as to shake the nail polish bottle 80 longitudinally to mix the nail polish uniformly. The nail polish bottle 80 is placed upside-down on the support member 50, and the fixture 62 can be used to clamp different sizes and types of the bottle 82, so that the nail polish bottle can be prevented from escaping from the support member 50 during longitudinal shaking. The control switch 70 is used to control different levels of motor speeds, such as a quick speed or slow speed, so that the user can shake nail polish bottle in quick or slow speed to uniformly mix the nail polish in stages according to property and the mix status of the nail polish. Therefore, the nail polish shaker of the present invention can improve the mixing effect for the nail polish.

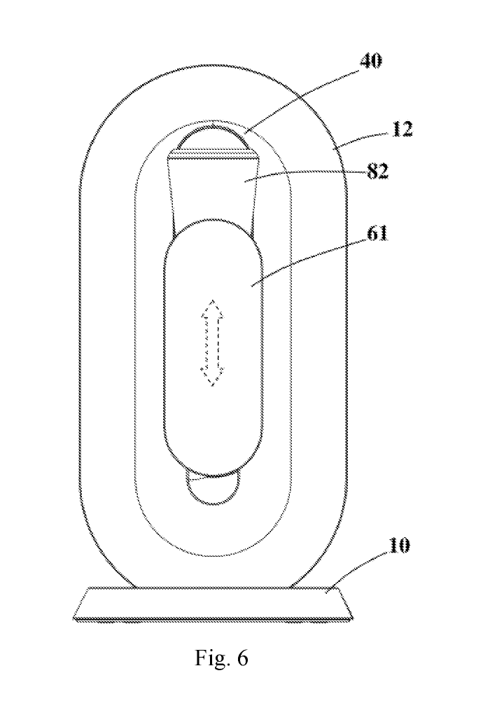

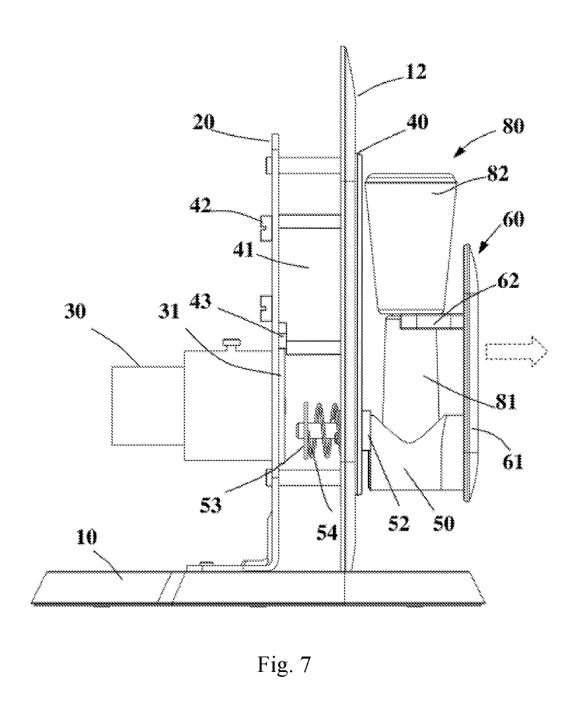

When the support member 50 and the restricting member 60 are kept in upright position as shown in FIGS. 6 and 7, the nail polish bottle 80 can be taken from or placed on the support member 50 through the top, of the nail polish shaker. Preferably, the support member 50 and the restricting member 60 are rotated to left or right side by a predetermined angle, so that the user can easily take or place the nail polish bottle 80 without rubbing against the panel 12. This function can be implemented by cooperation of the rotatable member 52 of the support member 50, the stop member 53 and the spring 54. When the support member 50 is applied a forward pull force, the spring 54 is compressed by the stop member 53 to enable the support member 50 and the restricting member 60 to move forward by a small distance and, in the meantime, the support member 50 and the restricting member 60 can be rotated leftward or rightward. Preferably, the rotation angle is 45 degrees. After the support member 50 and the restricting member 60 are rotated to the predetermined angle, the pull force applied on the support member 50 can be released to enable the rotatable member 52 and support member 50 to back to their former positions subject to the elastic force of the spring 54. Based on the friction between the support member 50 and the carry plate 40 or the panel 12, the support member 50 and the restricting member 60 can be positioned in any desired location and angle for easily taking or placing the nail polish bottle 80. By the same way, the support member 50 and the restricting member 60 can be rotated back to the original vertical positions.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A nail polish shaker, comprising:
a base, combined with a shell member which has a front part combined with a panel;
a mounting frame, fixed on the base and located inside the shell member;
a motor, fixed on the back of the mounting frame and having a rotation axis passed through the mounting frame to connect with a cam;
a carry plate, located on a front side of the panel and having a slidable member located on the back thereof, and wherein the slidable member is passed through longitudinal holes of the panel and the mounting frame to connect with the mounting frame and has a contact member located at a bottom thereof to be contacted with an edge of the cam;
a support member, having a bracket disposed thereon and having a rear end connected with the carry plate;
a restricting member, comprising a front panel and a fixture connected with the front panel, wherein the front panel is connected to a front end of the support member, and the fixture is located over the bracket.

2. The nail polish shaker according to claim 1, further comprising a microprocessor assembly coupled to a power unit and a control switch of the nail polish shaker, and the motor.

3. The nail polish shaker according to claim 1, wherein the support member has a rotatable member disposed at a rear end thereof and inserted through round holes of the carry plate and the panel, and the round holes has diameters with each other.

4. The nail polish shaker according to claim 1, wherein the bracket is configured to support a lid of a nail polish bottle, and the fixture is configured to clamp a bottle of the nail polish bottle.
